(19) United States
(12) Patent Application Publication
(10) Pub. No.: US 2022/0189353 A1
(43) Pub. Date: Jun. 16, 2022

(54) SYSTEM FOR DISPLAYING PRICES BY MEANS OF A DISPLAY PANEL

(71) Applicant: VISI/ONE GmbH, Remscheid (DE)

(72) Inventors: Konstantin KALHEBER, Berlin (DE); Stefanie KALHEBER, Wermelskirchen (DE); Michael KALHEBER, Wermelskirchen (DE)

(73) Assignee: VISI/ONE GmbH, Remscheid (DE)

(21) Appl. No.: 17/442,865

(22) PCT Filed: Mar. 26, 2020
(86) PCT No.: PCT/EP2020/058566

§ 371 Date: Sep. 24, 2021

(30) Foreign Application Priority Data
Mar. 26, 2019 (DE) 10 2019 107 731.1

(51) Int. Cl. G09F 21/04; G09F 27/00; G09F 3/20; G06Q 30/02; H04W 4/23; H04W 4/40

(52) U.S. Cl. CPC G09F 21/0485; G09F 21/046; G09F 27/005; H04W 4/40; G06Q 30/0266; H04W 4/23; G09F 3/208

(57) ABSTRACT

A system for displaying prices has a display panel in which a wirelessly controllable display apparatus having a display and a device for wireless acquisition of data is arranged. The display forms an image on the basis of received data, wherein a temperature sensor is also provided in the display panel and a receiving module is provided for receiving and processing data. The system has a control device which is formed on the display panel and which, on the basis of signals from the temperature sensor, can activate or deactivate the receiving module independently of received signals.

### CROSS REFERENCE TO RELATED APPLICATIONS

This application is the National Stage of PCT/EP2020/058566 filed on Mar. 26, 2020, which claims priority under 35 U.S.C. § 119 of German Application No. 10 2019 107 731.1 filed on Mar. 26, 2019, the disclosure of which is incorporated by reference. The international application under PCT article 21(2) was not published in English.

### AREA OF TECHNOLOGY

The invention relates to a system for displaying prices by means of a display panel, in which a wirelessly actuatable display apparatus with a display and a device for the wireless acquisition of data are arranged, in particular in relation to motor vehicles, wherein the display builds an image based upon received data, wherein a temperature sensor is further provided in the display panel, and a reception module is provided for receiving and processing data.

The invention further relates to a system for displaying prices by means of a display panel, in which a wirelessly actuatable display apparatus with a motor vehicle and a display panel arranged in the motor vehicle.

The invention finally relates to a system for displaying prices by means of a display panel according to the features in which a wirelessly actuatable display apparatus with a display and a device for the wireless acquisition of data are arranged, in particular in relation to motor vehicles, wherein the display builds an image based upon received data.

### PRIOR ART

Such a system for displaying prices by means of a display panel is known from prior art. For example, reference is made to DE 10 2015 121 285 A1. The display panel, for example price display panel, is provided with a wirelessly actuatable display, in particular with a display in the form of a known E-paper. Texts or images are here preferably permanently displayed, without a float voltage being required for this purpose. However, the indication on the display can be changed.

Known from DE 10 2017 113 278 A1 is a type of system in which access is provided to the display panel with a control device, and a temperature sensor can also be provided. However, the energy consumption of such a system is still estimated to be comparatively high. The temperature sensor can be used to activate or deactivate an image buildup, independently of received signals.

Known from US 2003/0132924 A1 is an E-paper display apparatus that can also have an accelerometer. The accelerometer is used to transmit a signal upon detection of an acceleration, which is recorded or displayed.

With regard to a system for displaying prices, a more favorable functionality is desired.

### SUMMARY OF THE INVENTION

Proceeding from the described prior art, the invention takes up the task of indicating a system for displaying prices by means of a display panel, possibly with the system comprised directly of a motor vehicle and the display panel, which can be operated as energy efficiently as possible, and with regard to an arrangement in a motor vehicle can be favorably localized, e.g., on a large parking lot, and in addition can advantageously display new data.

This object is initially achieved in a system having a control device formed on the display panel, possibly connected directly with the display, which activates or deactivates the reception module based upon received signals of the temperature sensor, independently of received signals, that a temperature monitoring of the system takes place only in the deactivated state, that the control device can be used to automatically generate a message on the display and/or a radio message, that the message determines the readable appearance on the display as long as the reception module is turned off, and that the appearance of the display after the message has appeared cannot be changed until the reception module has been reactivated.

This object is further achieved with a system being designed to receive and evaluate GPS signals of the motor vehicle in which the display panel is located, so that a calibration can be performed on the GPS signals on the panel side and motor vehicle side, and such a calibration can be used to check whether the display panel still remains allocated to the correct motor vehicle.

Finally, this object is also achieved with a system having an accelerometer on the display panel, with GPS data only being retrievable if a movement of the display panel, and hence of the display or the motor vehicle in which the display panel is located, was determined based upon the motion sensor, and with the display panel performing an unscheduled query with regard to any new data based upon a movement, so that a shaking motion, for example, triggers an updating command, e.g., a comparison of the data shown on the display with the data stored in a cloud, for example, which can be allocated to the display panel.

The temperature sensor of the display panel monitors a temperature range permissible for the display panel, in particular for the electronic components of the display panel. If this permissible temperature range is fallen below or exceeded, a reaction is triggered that protects the electronic components of the display panel, such as or even in particular the display. Work can here be done with so-called events. One event can here be preferred: “Permissible temperature range exceeded”. Exceeding the temperature in this way preferably switches the display panel, in particular its electronic components, and further in particular the display, preferably into a sleep mode. Accordingly, a reaction and possibly a change in the display indication takes place in particular in relation to the display, independently of signals and data received via the reception module.

In addition to the system deactivation described above, an activation can take place via the temperature monitor even when the permissible temperature range has been reached again, after which the display can again render the data and graphics displayed prior to the deactivation. Activation and/or deactivation can be directly controlled by software. Controlled by software, a queue of sorts can be generated with respect to actions to be performed, such as changes in the information content of the display, with the queue then being processed as a function of the temperature. Only once a sensible temperature specified for the system has been reached can processing take place in this way.

In a preferred embodiment, only a temperature monitoring of the system takes place in the deactivated mode, preferably the so-called sleep mode. In particular a communication by the system via the reception module (if necessary, additionally or alternatively via a transmitting module) with a preferably external communication system (PC, tablet, smartphone, cloud, etc.) here preferably does not take place.

If the temperature again reaches a value below the permissible range, another event is triggered, for example: (“Permissible temperature range reached”), and the display again switches back into the regular operating mode.

Based upon the calibration with the motor vehicle with regard to the GPS signals, a calibration of the GPS signals on the panel side and motor vehicle side is performed. Such a calibration can further be used to check whether the display panel still remains allocated to the correct object, for example the motor vehicle.

In a preferred embodiment, the GPS coordinates of the display panel and/or, after a corresponding reception, the GPS data of the motor vehicle or some other device can be retrieved at any time, for example via cloud software. In particular, it is preferred that the display panel automatically send out GPS coordinates, e.g., to a specific event, as yet to be explained below. The determined event can be a completed movement of the display panel, which was acquired by a motion sensor, as also yet to be explained below.

The smartphone user can be guided to the motor vehicle of interest to the user utilizing the GPS data of the display panel and/or the motor vehicle, for example by way of a corresponding smartphone app, e.g., on a larger terrain.

The acquired GPS data can also be used to record a route that the device, in particular the motor vehicle, might have taken, as long as the display panel is still located in or on the motor vehicle.

In another possible embodiment, the system of the display panel can possibly also receive and evaluate additional information about the allocated motor vehicle or the allocated device, for example the battery charge status of the motor vehicle. Problems are here frequently encountered, since the batteries of the motor vehicles discharge given a longer service life. For example, a correspondingly generated indication, for example which can be transmitted via a radio module, can help the motor vehicle dealer preventatively charge the battery again.

The display can also be dividable into different areas, which can be actuated independently of each other in terms of design/labeling, wherein the actuation of one of the several areas can take place independently of control by the system.

In this regard, importance is also attributed to the fact that areas of the display are only to be partially actuated for updating purposes, ultimately allowing energy to be economized once again. The display can be “updated”, as it were, based upon defined coordinates with respect to the information.

These different areas can also be referred to as templates. The actuating capacity here derives from the fact that, depending on a specific authorization or even a given accessibility to the specific area of the display, the organizational unit—e.g., a company, a specific division of a company or an authority—that is authorized or has access can determine, change, and unlock the content (text/image) of this display area.

This can be important in practice from the standpoint that, when using the display panel of motor vehicles available for sale or lease or the like, such as new cars or used cars, the respective dealer for these motor vehicles can utilize a first, specific area of the display for information, which can relate to the (technical) vehicle data as such, and further to the sales price or a leasing rate, for example, while another area of the display can be utilized by a financing institution, such as a bank, and renders financing terms as information, for example. There can here also be a more extensive hierarchy, e.g., which allows the dealer to also determine whether this additional area is even authorized, and possibly for which financing institution. The dealer can ultimately also preferably determine that the area that previously could only be informationally accessed by the financing institution is now again supplementarily available to the dealer, for example after a completed sale. For example, as concerns the disclosure of information that the motor vehicle was sold or information that the motor vehicle is on a test drive and/or information that a comparable motor vehicle can be inspected at a specific location.

The display can be individually configured in this way. For example, an area of the display can have a conventional, for example manufacturer-dependent designer look, while another area displays individual data and graphics, in particular adjusted to the device, for example a motor vehicle.

The display areas can basically be supplied via different sources. For example, there can be a connection with a database, e.g., which compares the respective currently marked price (preferably shown in a separate display area from this area) with a usual market price, and displays the resultant difference. In one possible embodiment, the user—e.g., car dealership—can activate or deactivate the display of such an area or actuation of such an area. Once such a display area has been activated, this display area can be configured and updated independently of any action by the user, e.g., car dealership.

In addition, various templates can be provided. For example, if a sales price of a motor vehicle is displayed, an installment amount can be indicated for installments. For example, the template can here be transformed into the type that is normally used given a combined display of the sales price and installment price.

So-called namespaces are placed in the corresponding software for the targeted actuation of display areas, wherein namespaces for templates of the display can also be specified, so that the user—e.g., the car dealership—cannot change them. These namespaces are then recorded via the third-party supplier, for example a bank that offers installment payments.

The accelerometer is used to determine whether the display panel was moved, wherein this is often associated with using the display panel, e.g., in another motor vehicle. As a consequence, a check can be performed to see whether the data reproduced on the display are still current, or should be changed.

In one primary use of the acceleration sensor data, the retrieval of GPS data is controlled or triggered if a movement of the display panel, and hence of the display or motor vehicle in which the display panel is located, was determined based upon the motion sensor. This is advantageous with respect to an energy-saving use of the display, since the retrieval of GPS data is associated with a significant energy outlay in relation to the energy amounts relevant here.

Another piece of information that can be obtained from motion sensor data is information that a movement as such is happening or has happened, e.g., a theft or removal of the display panel from a specific motor vehicle. In addition, recorded data from the motion sensor can be used to arrive at determinations as to whether a specific damage to the display panel discovered later can be traced back to a drop or hard impact.

The fact that the data reproduced on the display are possibly no longer current and require updating is indirectly associated with one or several of the above processes. For example, this can be the case if transmitted GPS data suggest that a vehicle ride, e.g., a test drive, is underway or took place. For example, it may then be advisable to use the display for the “Test drive” information or the like.

For example, the accelerometer can involve a piezoelectric sensor for measuring (linear) accelerations). Microelectromechanical systems (MEMS) are also possible in this regard. These sensors are spring-mass systems, in which the “springs” consist of silicon webs that are only a few micrometers wide, and the mass is also made out of silicon.

According to a further development, the display panel can in this conjunction perform an unscheduled query with regard to any new data based upon a movement. For example, the motion sensor can be used to update the display panel or the display module through an alternating motion (shaking). The shaking motion triggers a corresponding update command, or a comparison of the data shown on the display with the data stored in a cloud, which can be allocated to the display panel.

A motion sensor can further be used to allow physical changes in the state of the display apparatus. For example, a display apparatus can be switched from a deep sleep state into a receive state, wherein the prescribed deep sleep interval can here be interrupted, induced by a sensor.

The motion sensor can also be used to trigger an alarm of an alarm system. For example, if motion sensor data suggest that the vehicle has been jacked, or also that a door or a window has been opened. The latter owing to any shocks associated therewith, but also due to a movement by the display panel caused by a draft, wind.

Furthermore, a possible locating function can also be coupled with a motion sensor, so as to make locating energy efficient in this way. Aside from issuing a locating instruction by means of a data packet or predefined program logics, the locating instruction itself can be generated for a display that is in the deep sleep mode. The localizing circuit can here further only be activated with the display panel in a rest position for a defined time interval after the last movement. In addition, this can take place in such a way that the motion sensor waits for a movement by the device logic until the sensor information is no longer to be registered as a movement. If necessary, the device logic can immediately thereafter either persist a timestamp, which is compared with the current time at regular intervals, and/or activate a timer that keeps track of the elapsed time. As long as a movement is registered, either nothing can be undertaken, or the timer or timestamp is reset.

Furthermore, the time stamp can be persisted as described above or the timer can be activated once the end of a movement can be inferred from the sensor information. As soon as the timer has expired with a defined time or the timestamp has a defined time difference from the current time, the locating instruction can be generated. The timer or timestamp can then be eliminated.

If another movement is registered during an active timer or persisted timestamp, wherein the preset time has not yet elapsed, the process as described above can start over again, and the set timer or timestamp can be set in such a way that the set time interval begins to run once again.

It can here be possible to define which measured values are regarded as a movement (sensitivity setting). In the case of an accelerometer (acceleration sensor), for example, a minimal value (trigger value) can be defined for the sum of the accelerations on all three axes.

Two or more memory modules can also be provided on the display panel, of which a first memory module stores a currently used firmware, and a second memory module the firmware used immediately before.

The display panels described here and in further detail the mentioned displays of the display panels as well each preferably have a separate identification number (ID), in particular an internet identification number.

In one key example for the use and importance of these ID's, for example, a display panel can also comprise two separate displays, meaning not just different areas on a display. Each display can here have a separate ID, and the display panel as such can in turn also have a separate ID. The displays can then be actuated by various units (companies, organizations) or left to the latter for the dissemination of information. Using software to connect the ID's of these displays with the ID of the display panel makes it possible to recognize which specific organizational unit, for example a motor vehicle dealer, is to have this display panel with the two displays mentioned in the example allocated to it, wherein the latter can in turn be informed about which other organizational unit has access to the additional display based upon this correlation, for example.

The memory modules are preferably designed as a controller, and can on the one hand be allocated to a specific hardware/firmware, i.e., control and implement these hardware or firmware executions. On the other hand, they can be used for communication in the mobile network to the nearest cell tower. In terms of data technology, this can be associated with a special cloud application for integrating several of these display panels or possibly all display panels in operation. Communication can take place via a mobile communications standard like NB-IoT or CaT-M1.

Due to this embodiment, the system, in particular as relates to the electronic components, such as further in particular the display and/or accompanying control modules, can be set to updatable with respect to the firmware. Specifically provided for this purpose are two memory modules, of which one contains the current update, and the other retains the last version that ran without errors. For example, if an error arises while implementing an update, the last version that ran without errors can be accessed again at any time.

The system can activate or deactivate the reception module independently of received signals as a function of the signal of the temperature sensor and/or in which GPS signals of another device, in particular of the motor vehicle in which the display panel is located, can be received and evaluated, and/or in which the display can be divided into different areas, which can be actuated independently of each other in terms of design/labeling, wherein the actuation of one of the several areas can take place independently of control by the system, and/or in which an accelerator is provided on the display panel, and/or two or more memory modules are provided on the display panel, of which a first memory module stores a currently used firmware, and a second memory module the firmware used immediately before.

The control device is used to automatically generate a message on the display and/or a radio message, this in particular given a deviation of the temperature value acquired via the temperature sensor in relation to the permissible temperature range. As also preferred, this message can relate in particular to deactivating the display and/or, given a deactivation of the control device, to displaying the measured temperature on the display.

As already noted, a display further also has a separate battery, in exceptional cases also a separate accumulator. A message could also be generated on the display to the effect that a battery has to be replaced, e.g., before a display is placed in the vehicle again.

The message can further determine the readable appearance on the display as long as the reception module is turned off. The usual display, for example specific data for a motor vehicle that is for sale or the like, can be hidden given a deactivation of the reception module, and replaced with a corresponding message that the temperature range has been fallen below or exceeded. Alternatively, an indication can also be shown that no updating is currently taking place, since the temperature range has been exited. According to a possible embodiment, this message can also be provided in addition to the usual (“frozen”) article display.

In any event, the display indication is not updated in relation to data about the device, for example the motor vehicle, over the period for which the temperature range has been exited.

According to a possible embodiment, the appearance of the display after the message has appeared cannot be changed until the reception module has been reactivated. The display or the.

The control device can also further be designed so as to be able to check the timeframe within which use is made of the updatability of a display panel at a user, for example a car dealership. Based upon the empirical values collected in this way, a deactivation can then take place for the timeframe that is usually not used. This goal of this measure is also to keep energy consumption as low as possible.

In another possible further development, image information updates can only be generated if a date of a displayed dataset changes. A check can here have been run beforehand to determine whether this date is important for the actual indication on the display, for example the visually discernible information would actually change. In a preferred embodiment, no update is performed if the update would not change the displayed image. This process can take place in several examination steps, depending on the used image generating steps. The method can further be implemented either by means of an actual and target analysis, or via software-supported deductive methods for determining the update necessity.

With regard to the already addressed templates, it is further preferred that the latter change automatically, controlled by data or time. A different display layout with the provided access options for the various institutions thus arises, as touched upon further above. For example, a data-controlled change can be triggered given the sale of a motor vehicle, a car, for example. An automatically actuatable area of the display can then be eliminated, for example for a financing organization, since it is no longer relevant. A change can also be triggered in a time-controlled manner if, at a specific time of day, on a specific weekday (with a specific time) or in a specific month, no information automatically appears in the area that had previously been reserved in the template of the financing institution, for example, instead of which the surface of the display as a whole is only still being used by the dealer, e.g., with the indication “Special price” or “Discount promotion” or the like.

As preferred in another application, when such cars are being traded and sold online, an additional data-controlled change can involve the display then changing automatically on the display panel in an open space or in a hall where the respective car is actually located as a result of the online sales event.

It is also important that the program used to control the display panel or the radio module of the display panel be cloud-based. Accordingly, a user such as car dealership does not have to install any separate hardware.

A user can log in with their access data via a common browser. No separate software is required for use.

The login procedure can be performed according to another possible embodiment or via an app, for example via a smartphone app, wherein this app possibly also permits a few additional possible interactions. For example, a QR code can be scanned so as to marry (pair) a display with a vehicle dataset.

Each display panel has a separate internet address (ID), as already touched upon earlier. With regard to an initial delivery of a display panel, it is here in particular preferred that it also have a physically visibly affixed ID, in particular in the form of a label preferably applied to the back side of a display panel. The ID can here be reproduced in plain text, expressed as figures. Additionally or alternatively, however, a QR code can also be reproduced on this label, which stands for the ID or also for additional information. For example, it is only depending on a scanning of this QR code and/or an input of the mentioned ID into an app, for example of the dealer for motor vehicles, that an organizational realignment can take place indicating that the actual sales transaction relating to the display panel as such and a switchover to management by this dealer have taken place. From this time forward, the exemplary dealer him or herself can then possibly determine the content of the information of the. respective areas of the template, as also described further above. In this way, he or she can then also release or determine additional information, e.g., for scanning by an interested party, or via QR codes directly shown by the display itself.

The cloud application is responsively programmed to be correspondingly operated on various terminals, such as PC's, tablets, or smartphones, wherein a multitenant (client-enabled) architecture is preferably used. Client-enabled denotes information technology that can serve several clients on the same server or the same software system (the cloud here), without one being able to view the other's data, user management, and the like.

In a possible embodiment, the display panel freely usable in a motor vehicle, for example, can be utilized to control specific motor vehicle functions, e.g., to unlock or lock the motor vehicle doors or open or close the side windows.

Each display panel can also be provided with a separate lighting element, for example an LED lighting element. As already stated above with regard to the motion sensor and/or the temperature sensor, the LED lighting-element is also preferably allocated directly to the display. For example, this makes it possible to show a user which motor vehicle among a variety of motor vehicles reflects what he or she wants, namely the one in which a corresponding light signal is activated on the display panel. The user can select a specific class or specific types of cars, motor vehicles, via an app on his or her mobile phone, which can then “report”, for example, by means of the display panel via corresponding light signals.

Various display technologies can be used. For example, an electrophoresis display can be used, which is known under the usual market designation ESL (electronic shelf labeling) or E-ink. The technology of bistable LCD's (coloristic LCD=ChLCD) can also find application.

Conventional mobile communication standards are used in particular for cloud-based control. As initially preferred, use can be made of LTE Cat NB1 (NB-IoT). This narrowband IoT is a partial area of the usual LET standard, but confined to a bandwidth of about 180 KHz in the half duplex mode. Alternatively, LTE CaT M1 (eMC) can be used as the mobile communication standard, with a bandwidth of about 1.4 MHz in the full or half duplex mode.

In another embodiment, the longevity in particular of, the display apparatus can be increased and energy-efficient display panels or displays can be offered by providing dynamic energy saving plans, for example based upon a manual configuration and/or software algorithms and/or machine learning and/or artificial intelligence. In a preferred embodiment, such energy saving plans can here be generated not directly in the display panel or in the display, but rather in a cloud, as also preferred. For example, this can done with the inclusion of the configuration stored for the display panel (e.g., uplink intervals, operating restrictions, temperatures, etc.) and/or (all) data and sensor data acquired by the display panel or display (e.g., temperature progressions, radio quality, battery status, location/height, etc.), both as a snapshot date and as a history date, and/or with the inclusion of data about user interactions and/or data about automatic interactions and/or external data, for example weather forecasts for the device location.

This information can here be used to control the individual activity behavior of the display panel, so as to optimize the energy consumption. The cloud system can here execute the authorization for optimization automatically or through manual request, and generate machine-readable instructions that can control the parameters of the display panel. Such parameters can be the deep sleep cycles and/or uninterrupted deep sleep intervals, in which the display panel is predictably unable to perform any actions, for example due to the environmental conditions, and/or if-this-then-that instructions, which move the display panel into a specific operating state depending on instructions and/or device-specific sensor information, the end of which and a defined subsequent state can be triggered by device-specific sensor inputs.

These machine-readable energy saving plans can be transferred to the respective display panel and stored there. The display panel can then correspondingly adjust the configuration, and follow the operating instructions of the energy saving plan. With regard to the GPS module and/or the temperature sensor, and possibly additional functional parts that influence communication or display layout, it is preferred that these functional parts be directly allocated to the actual visible surface of the display, and located on a circuit board arranged behind the visible surface, for example. The displays are typically manufactured and handled as a unit with the circuit board.

This usual sales unit of a display preferably consists of a rigid circuit board of the kind also known as other circuit boards for electronic components. These contain the electronic modules that are required or desired for the display or specially provided according to the present application. The circuit board can then be connected with the actual display via inherently flexible conductor connections. During assembly, the circuit board can be folded toward the back on a rear side of the display, and the assembly as a whole can in this way be accommodated in a housing of the display panel.

### BRIEF DESCRIPTION OF THE DRAWINGS

The invention is explained below based upon the attached drawing, but the latter only shows exemplary embodiments. A part that is only explained in relation to one of the exemplary embodiments and not replaced by another part in another exemplary embodiment based upon the characteristic highlighted therein is thus also described for this additional exemplary embodiment as a part that can at any rate be present. The drawing shows:

FIG. 1 a perspective view of a display panel relating to a first embodiment;

FIG. 2 the display panel in a possible use position with the display panel arranged in a motor vehicle;

FIG. 3 the display panel in a view relating to another embodiment;

FIG. 4 another perspective view of a display panel in another embodiment;

FIG. 5 another embodiment showing the display panel in a perspective view.

### DESCRIPTION OF THE EMBODIMENTS

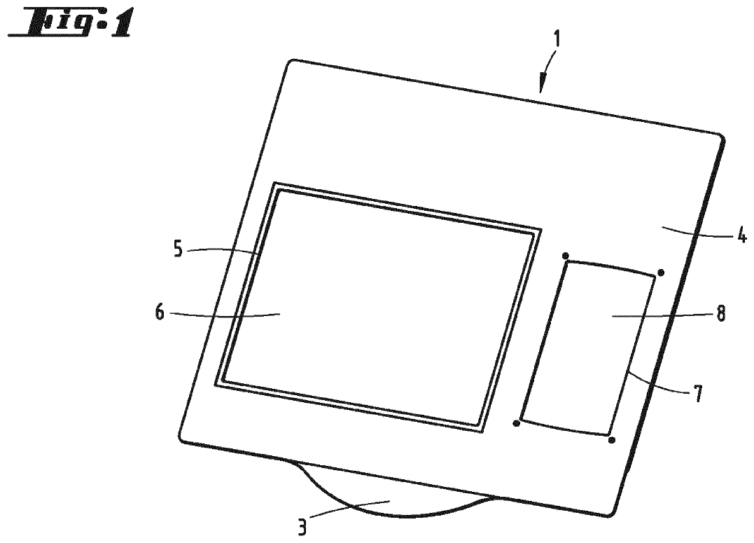

Illustrated and described initially with reference to FIG. 1, for example, is a display panel 1 that can have a rectangular horizontal projection, for example with an aspect ratio of about 1:1.5 to 1:3, and a longer edge length of 100 to 1,500 mm, further for example about 400 to 700 mm. For example, this display panel serves as a price marking panel for a motor vehicle 2.

For example, a display panel 1 of the kind in question is known from DE 10 2017 113 278 A1. The content of this patent application is hereby included in the disclosure of the present invention in its entirety, further for the purpose of also including features of this patent application in claims of the present invention.

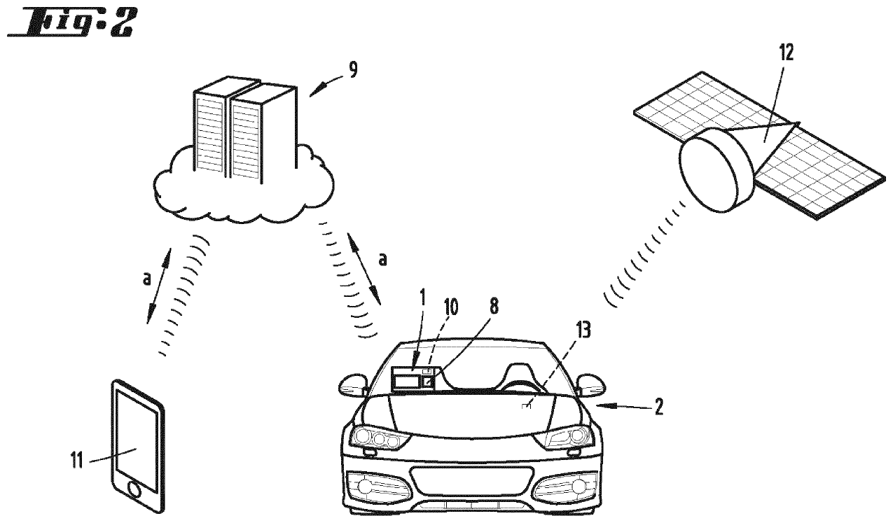

As also depicted, the display panel 1 can have an insertion section 3 in the area of the downwardly facing narrow edge in the use state of the display panel 1. This insertion section can be used to pin lock the display panel 1 in a motor vehicle, for example via insertion into a vent slot or at any rate through insertion behind the windshield (see FIG. 2).

The insertion section 3 can here be designed as one piece and materially uniform with a visible outer layer 4 of the display panel 1, which preferably has a multilayer overall design.

The display panel 1 can essentially have a three-layer design, with two outer layers 4 that essentially comprise the horizontal projection, and a middle layer. A single-layer configuration is also possible.

The individual layers can be adhesively bonded with each other to form the display panel 1.

According to the illustration on FIG. 1, the display panel 1 can have a viewing window 5 that is clear cut in the outer layer 4. An information sheet 6 can be introduced behind the latter. This can be a printed paper or film sheet.

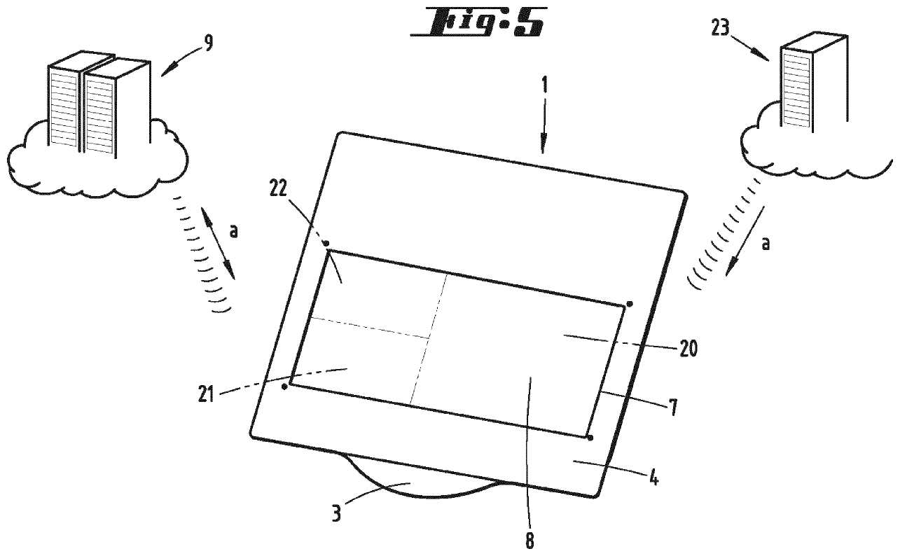

A passage opening 7 with an essentially rectangular horizontal projection can be provided, either situated adjacent to the viewing window 5, or also according to FIG. 5 solely determining the display panel 1. Given multiple layers, this passage opening 7 can penetrate through both outer layers as well as the middle layer.

A display 8 is preferably arranged and retained in the through opening 7 in the form an E-paper. The display 8 is part of a display apparatus. Depending on the selected thickness of the display panel 1 as a whole viewed perpendicularly to the surface extension, the display 8 or the display apparatus can be at least approximately completely accommodated in the panel 1, or given a comparatively smaller thickness preferably protrude over the rear surface of the outer layer.

The display 8 is designed for wireless actuation or for the wireless acquisition of data. The display 8 builds an image based upon the received data.

The passage opening 7 is preferably provided with a size that not only exposes the actual visual surface of the display, which can reproduce various information, through the opening to the front, toward the viewer, in the installed state, but rather also another area that belongs to the display in a broader sense, i.e., can be an area directly connected herewith. In particular, this connected area can then have the antenna with regard to the mobile radio module of the display, so that this area with the antenna is not covered toward the front by materials that impede radio accessibility. In the actual embodiment, a color film otherwise adjusted to the display panel can evoke the impression in a viewer that the passage opening is actually confined only to the area of the display suitable for the changing information. In particular, it is preferred that a viewer be unable to discern from outside that an antenna or similar technical part is located in the additional area of the display that is basically exposed to the outside.

The data for generating the image to be displayed are preferably stored and kept in a dedicated database of a wirelessly connected computing system 9. As also preferred, this case can involve a cloud-based database.

The display apparatus of the display 8 can be designed for bidirectional data exchange (see arrow a on FIG. 2).

Dynamic image data generation takes place in the preferably cloud-based computing system 9 based upon datasets. Accordingly, the image is completely generated before transmitted, and shown on the display 8.

The display apparatus of the display panel 1 preferably has a unique internet and/or mobile radio ID, and further in particular a unique physical address.

A common mobile communications standard can be used for wireless communication, for example NB-IoT or CaT-M1.

It is further possible to provide the display panel 1, in particular the display apparatus of the display 8, or a plug-in board allocated to the display apparatus, with one or several slots, wherein a mobile radio module or alternatively or additionally thereto a positioning module, for example in the form of a GPS module 10, can be plug-in mounted in these slots, for example.

The GPS coordinates of the display panel 1 can likewise be stored in the cloud or computing system 9. This provides the option of also retrieving these GPS coordinates, and possibly a coordinate progression over a preset period while using a terminal 11, for example a smartphone. This terminal 11 is also preferably in bidirectional contact to the computing system 9.

With regard to the wireless connection between the terminal 11 and the computing system 9, as well as between the computing system 9 and the display panel 1, a full duplex or even half duplex mode can be involved.

For example, the GPS function can further be used to also record a travel path of the motor vehicle 2 provided with the display panel 1, and store it in the computing system 9.

Furthermore, the system can be suitable for receiving signals, in particular GPS signals of another device, here in particular the motor vehicle 2. The GPS data received in the usual manner via a GPS satellite 12 in the onboard GPS module 13 can be transmitted to the receiver of the display panel 1. These data can be relayed to the computing system 9, and there possibly processed. Therefore, the computer software can be used to calibrate whether the display panel 1 provided with a specific ID is also located in the correct motor vehicle 2.

In a possible embodiment, the vehicle bus system can be used to identify the motor vehicle 2 and send a data/image query to the computing system 9. Vehicle-specific data can then be retrieved via the latter.

For this purpose, the display apparatus of the display 8 can have a corresponding interface, for example a radio interface.

In particular for economizing energy in the preferably accumulator-powered display apparatus, the display 8 builds an image or rebuilds an image at larger time intervals than correspond to the time interval relative to data transmission for an image buildup of the display 8. For example, an image can be regularly rebuilt every fifteen minutes, half hour or even hour.

In order to directly build or rebuild an image, the display apparatus of the display 8 can also be separately actuated, for example remotely using the computing system 9 or the terminal 11. As also the case for implementing additional functions or retrieving information, use can for this purpose also be made of an application stored on the computing system 9 (the cloud here), which can be operated via a common browser on the terminal 11.

In order to directly build an image, the terminal 11 can be used to direct a corresponding command to the display apparatus with the application via the computing system 9.

A pushbutton or the like can also be provided directly on the display panel 1 for triggering such a rebuild.

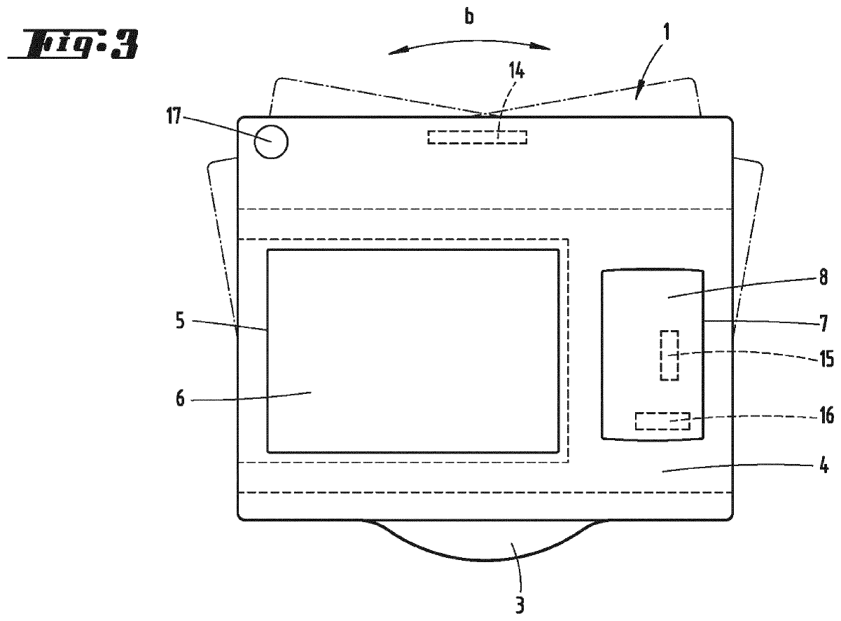

As schematically depicted on FIG. 3, the display panel 1 can further have an accelerometer 14. The latter can be used to acquire a possible movement of the display panel 1, for example the removal of the display panel 1 from the motor vehicle 2, and report it to the computing system 9 via the radio module.

However, the accelerometer 14 can further also be used to generate a command for directly implementing an image rebuild of the display 8. In a possible embodiment, the display panel 1 can for this purpose be shaken or moved back and forth (symbolized by arrow b on FIG. 3). This back and forth movement of the display panel 1 is acquired by the accelerometer 14, as a result of which a corresponding signal is generated.

According to the illustration on FIG. 3, the display panel 1 can also have a battery sensor 15 for monitoring the charge status of the display panel accumulator.

In addition, a temperature sensor 16 can further or alternatively be provided, which in particular acquires the temperature directly in the area of the display 8.

If a preset temperature range within which the display 8 functions properly is exceeded or fallen below, a signal can be generated to sign out of the display panel 1 or the radio module of the display panel 1. After this, the appearance of the display 8 is no longer updated due to the deactivation of the radio or reception module, even if an attempt is made to transmit a corresponding dataset via the computing system 9.

The provided control device can rather automatically generate a message on the display 8 and/or a radio message via the computing system 9 to the terminal(s) 11.

Only after a temperature in the permissible range has been acquired is the reception module or radio module reactivated, and the appearance of the display 8 adjusted as needed.

In another possible embodiment, the application used via the terminal 11 can have a search mode, with which the user of the terminal 11, after having set specific search criteria, for example a larger sales area, can find one or several motor vehicles 2 that match these search criteria.

To this end, use can be made on the one hand of the GPS module 10 of the display panel 1, so that the user with the terminal 11—in particular a mobile terminal 11 in the form of a smartphone or the like—is guided to the motor vehicle 2.

Alternatively or even additionally thereto, for example, the display panel 1 can also be provided with a lighting element 17, for example in the form of an LED. The lighting element 17 is activated via the computing system 9 as soon as the allocated motor vehicle 2 matches the search profile input via the app.

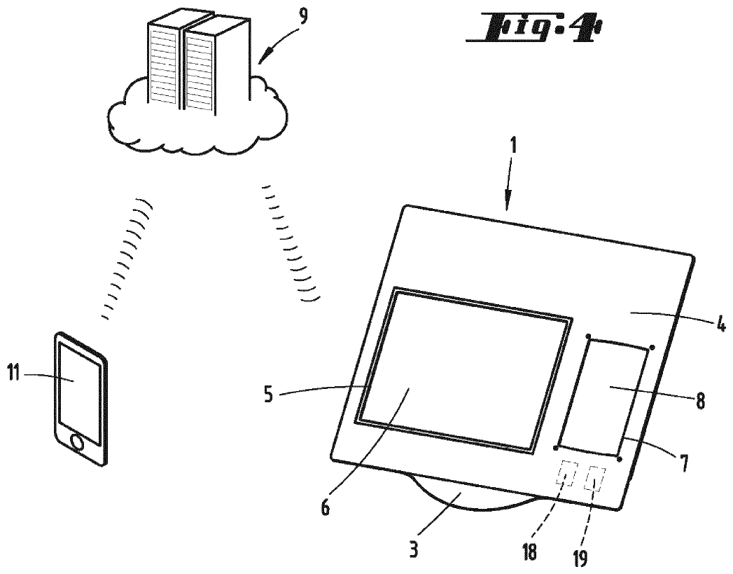

The cloud-based application advantageously eliminates the need to install software on the terminal 1. Rather, the user utilizes and possibly changes the data via a browser application (see FIG. 4).

The cloud-based application can optionally be provided with additional possible interactions, for example scanning a QR code.

In another embodiment, in particular the display apparatus of the display 8 is updatable with respect to the firmware, as are the accompanying radio module and possibly additional electric modules of the device. Preferably provided for this purpose are two memory modules 18 and 19, of which a first memory module 18 stores a currently used firmware, and a second memory module 19 contains the firmware used immediately before as a “backup”. Given a defective current firmware, the previously used firmware can be accessed.

As already explained further above, it can also be provided in particular that one memory module be responsible for the hardware/firmware, and the other for the communications software for wirelessly actuating the display panel or the display, e.g., via the NB-IoT standard.

As shown on FIG. 5, the display 8 can have a horizontal projection surface which, by comparison to the illustration on FIG. 1, also covers the area of the viewing window 5. The display 8 can further have a horizontal projection surface that overall can essentially correspond to more than half up to 90 or 95 percent of the free horizontal projection surface of the display panel 1.

The display 8 can further be divided into different areas 20, 21 and 22 with respect to the design and lettering. These areas can vary in design and lettering. A uniform lettering of all areas 20, 21 and 22 or even just a plurality of contiguous areas is also possible. Depending on the application, the boundaries between the areas can be visible by varying the design of the areas, or not visible given a (partially) shared design.

The areas 20, 21 and 22 can be actuated via different sources, wherein the actuation of an area 20, 21 and 22 can also take place independently of control by the system via the display apparatus. For example, a possibly preset area (for example, area 20 in the exemplary embodiment shown) can be actuated by a separately provided computing system 23, possibly a cloud-based computing system, via which only the area 20 can be graphically actuated. It is preferably not or only limitedly possible to influence the area 20 via the display apparatus and the system of the display panel 1 or via the computing system 9, at least given a corresponding access via an additional computing system 23.

While the area—here area 20—can indeed be designed and lettered via a separate computing system 23, this possibly takes place as a function of data kept in the computing system 9 for this display panel 1 or the allocated motor vehicle 2. For example, an advertisement or loan proposal from a bank can be displayed in the area 20 actuated via the computing system 23, either independently of or even dependent upon the allocated data in the computing system 9, which can at least partially be shown in area 21 and/or 22.

The varyingly actuatable areas 20 to 22—wherein two or more than just three areas can be provided, for example four, five or six up to ten or more—possibly also yield an optical division of the display 8.

In addition, various templates can be shown on the display 8, if necessary one allocated template per area 20 to 22.

The above statements serve to explain the inventions covered by the application as a whole, which each also independently advance the prior art at least by the following feature combinations, wherein two, several or all of these feature combinations can also be combined, specifically:

A system, characterized in that the system has a control device formed on the display panel 1, which can activate or deactivate the reception module based upon signals of the temperature sensor 16, independently of received signals.

A system, characterized in that the control device can be used to automatically generate a message on the display 8 and/or a radio message.

A system, characterized in that the message determines the readable appearance on the display 8, as long as the reception module is turned off.

A system, characterized in that the appearance of the display 8 after the message has appeared cannot be changed until the reception module has been reactivated.

A system, characterized in that the system is designed to receive and evaluate GPS signals of another device, in particular of the motor vehicle 2 in which the display panel 1 is located.

A system, characterized in that the display 8 can be divided into different areas 20, 21, 22, which can be actuated independently of each other in terms of design/labeling, wherein the actuation of one of the several areas 20, 21, 22 can take place independently of control by the system.

A system, characterized in that an accelerometer 14 is provided on the display panel 1.

A system, characterized in that the display panel 1 performs an unscheduled query with regard to any new data based upon a movement.

A system, characterized in that two or more memory modules 18, 19 are provided on the display panel 1, of which a first memory module 18 stores a currently used firmware, and a second memory module 19 the firmware used immediately before.

All disclosed features (whether taken separately or in combination with each other) are essential to the invention. The disclosure of the application hereby also incorporates the disclosure content of the accompanying/attached priority documents (copy of the prior application) in its entirety, also for the purpose of including features of these documents in claims of the present application. Even without the features of a referenced claim, the subclaims characterize standalone inventive further developments of prior art with their features, in particular so as to submit partial applications based upon these claims. The invention indicated in each claim can additionally have one or several of the features indicated in the above description, in particular those provided with reference numbers and/or indicated on the reference list. The invention also relates to design forms in which individual features specified in the above description are not realized, in particular if they are recognizably superfluous with regard to the respective intended use, or can be replaced by other technically equivalent means.

Reference List

| | | | |
|---|---|---|---|
| 1 | Display panel | a | Arrow |
| 2 | Motor vehicle | b | Arrow |
| 3 | Insertion section | | |
| 4 | Outer layer | | |
| 5 | Viewing window | | |
| 6 | Information sheet | | |
| 7 | Passage opening | | |
| 8 | Display | | |
| 9 | Computing system | | |
| 10 | GPS module | | |
| 11 | Terminal | | |
| 12 | GPS satellite | | |
| 13 | GPS module | | |
| 14 | Accelerometer | | |
| 15 | Battery sensor | | |
| 16 | Temperature sensor | | |
| 17 | Lighting element | | |
| 18 | Memory module | | |
| 19 | Memory module | | |
| 20 | Area | | |
| 21 | Area | | |
| 22 | Area | | |
| 23 | Computing system | | |

1-10. (canceled)

11. A system for displaying prices, comprising a display panel (1), in which a wirelessly actuatable display apparatus with a display (1) and a device for the wireless acquisition of data are arranged, in particular in relation to motor vehicles (2), wherein the display (8) builds an image based upon received data, wherein a temperature sensor (16) is provided in the display panel (1), and a reception module is provided for receiving and processing data, wherein, in an activated state, the display (8) builds the image or rebuilds the image at larger time intervals than correspond to the time interval relative to data transmission for an image buildup of the display (8), and further comprising a control device formed on the display panel (1), the control device being configured to activate or deactivate the reception module based upon received signals of the temperature sensor, independently of received signals, wherein a temperature monitoring of the system takes place only in the deactivated state, wherein the control device is configured to automatically generate a message on the display (8) and/or a radio message, wherein the message determines a readable appearance on the display (8) as long as the reception module is turned off, and wherein the appearance of the display (8) after the message has appeared cannot be changed until the reception module has been reactivated.

12. A system for displaying prices comprising a motor vehicle and a display panel (1) arranged in the motor vehicle, in which a wirelessly actuatable display apparatus with a display (8) and a device for the wireless acquisition of data are arranged, wherein the display (8) builds an image based upon received data, wherein the display panel (1) has a GPS module (8), wherein the system is designed to receive and evaluate GPS signals of the motor vehicle (2) in which the display panel (1) is located, so that a calibration can be performed on the GPS signals on a panel side and motor vehicle side, and such a calibration can be used to check whether the display panel still remains allocated to the correct motor vehicle.

13. A system for displaying prices comprising a display panel (1), in which a wirelessly actuatable display apparatus with a display (8) and a device for the wireless acquisition of data are arranged, in relation to motor vehicles (2), wherein the display (8) builds an image based upon received data, and the display panel has a GPS module (10), wherein an accelerator (14) is provided on the display panel (1), wherein GPS data can only be retrieved if a movement of the display panel, and hence of the display or the motor vehicle in which the display panel is located, was determined based upon the motion sensor, and wherein the display panel performs an unscheduled query with regard to any new data based upon a movement, so that a shaking motion triggers an updating command.

14. The system according to claim 13, wherein the updating command is in the form of a comparison of the data shown on the display with the data stored in a cloud, which can be allocated to the display panel.

15. The system according to claim 11, wherein the display panel (1) has a GPS module (8), wherein the system is designed to receive and evaluate GPS signals of the motor vehicle (2) in which the display panel (1) is located, so that a calibration can be performed on the GPS signals on a panel side and motor vehicle side, and such a calibration can be used to check whether the display panel still remains allocated to the correct motor vehicle.

16. The system according to claim 11, wherein the display panel has a GPS module (10), wherein an accelerator (14) is provided on the display panel (1), wherein GPS data can only be retrieved if a movement of the display panel, and hence of the display or a motor vehicle in which the display panel is located, was determined based upon the motion sensor, and wherein the display panel performs an unscheduled query with regard to any new data based upon a movement, so that a shaking motion triggers an updating command.
